(19) United States
(12) Patent Application Publication
(10) Pub. No.: US 2013/0042208 A1
(43) Pub. Date: Feb. 14, 2013

(54) CURSOR FOR ENHANCED INTERACTION WITH USER INTERFACE CONTROLS

(71) Applicant: Lucinio Santos-Gomez, Durham, NC (US)

(72) Inventor: Lucinio Santos-Gomez, Durham, NC (US)

(73) Assignee: INTERNATIONAL BUSINESS MACHINES COPORATION, Armonk, NY (US)

(21) Appl. No.: 13/206,953

(22) Filed: Aug. 10, 2011

(51) Int. Cl. G06F 3/048

(52) U.S. Cl. 715/862

(57) ABSTRACT

A method for enhanced cursor interaction with a user interface (UI) control, including: detecting a hover event by a cursor within a hot spot region of the UI control within a user interface, wherein the user interface is displayed on a display device; initiating a handle mode for the cursor in response to detecting the hover event; and extending the hot spot region beyond an initial boundary in response to initiating the handle mode.

### BACKGROUND

Interaction with user interface (UI) separator widgets, like sashes or column separators, that control the size or space allocation of UI areas (panes, column widths) can require fine motor control of the mouse cursor. Separator controls and other UI controls (including buttons and hyperlinks that perform specific operations) that may also require fine motor control of the cursor can make it difficult for users to use the UI controls accurately.

Hot spots of the controls, or areas in the user interface in which a user is able to activate the controls, may be limited by the width/height of the particular UI control, which can sometimes be as small as a few pixels wide/high. Moving the mouse cursor at regular speed can result in missing the hot spot and often results in spending time re-tracing the position of the cursor to find the small hot spot.

### SUMMARY

Embodiments of a method are described. In one embodiment, the system is a method for enhanced cursor interaction with a user interface (UI) control. The method includes: detecting a hover event by a cursor within a hot spot region of the UI control within a user interface, wherein the user interface is displayed on a display device; initiating a handle mode for the cursor in response to detecting the hover event; and extending the hot spot region beyond an initial boundary in response to initiating the handle mode. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of an enhanced user interface control system.

FIG. 2 depicts a schematic diagram of one embodiment of a user interface.

FIG. 3 depicts a schematic diagram of one embodiment of the user interface of FIG. 2.

FIG. 4 depicts a schematic diagram of one embodiment of the user interface of FIG. 2.

FIG. 5 depicts a flow chart diagram of one embodiment of a method for enhanced cursor interaction with a user interface control.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for enhanced cursor interaction with user interface (UI) controls. More specifically, the system implements a handle mode for a cursor in response to detecting a hover event for a UI control, and extends a hot spot region in which the UI control is usable while the cursor is in the handle mode. In some embodiments, the cursor is elastic, such that it stretches while the cursor is in handle mode to provide visual feedback to the user that the hot spot region in handle mode is extended. In some embodiments, the system exits the handle mode and restores the hot spot region to an original state when the cursor leaves the extended hot spot region.

In some conventional systems, small hot spot regions for certain UI controls or widgets that require fine motor control of the cursor in the user interface can make interacting with the UI controls or widgets difficult. In some instances, the hot spot regions can be as small as a few pixels vertically and/or horizontally on the user interface. Moving the cursor at regular speed can result in passing over the hot spot region, which may cause the user to spend additional time retracing the position of the cursor to find the small hot spot region. By implementing a handle mode that extends the original boundary of the hot spot region, the system and method improve user operability of UI controls by allowing users to more easily find and interact with the UI controls.

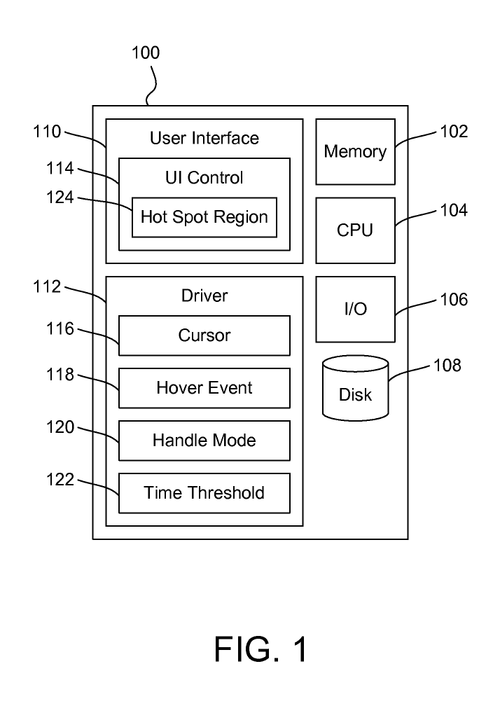

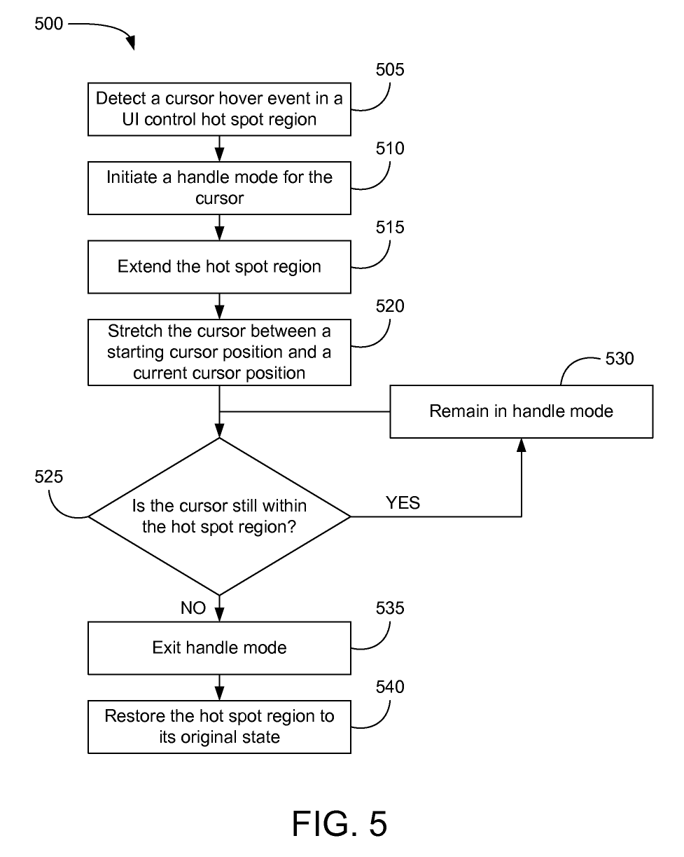

FIG. 1 depicts a schematic diagram of one embodiment of an enhanced cursor system 100. The depicted enhanced cursor system 100 includes various components, described in more detail below, that are capable of performing the functions and operations described herein. In one embodiment, at least some of the components of the enhanced cursor system 100 are implemented in a computer system. For example, the functionality of one or more components of the enhanced cursor system 100 may be implemented by computer program instructions stored on a computer memory device 102 and executed by a processing device 104 such as a CPU. The enhanced cursor system 100 may include other components, such as a disk storage drive 108, input/output devices 106, a user interface 110, and a driver 112. Some or all of the components of the enhanced cursor system 100 may be stored on a single computing device or on a network of computing devices, including a wireless communication network. The enhanced cursor system 100 may include more or fewer components or subsystems than those depicted herein. In some embodiments, the enhanced cursor system 100 may be used to implement the methods described herein as depicted in FIG. 5.

In one embodiment, the enhanced cursor system 100 includes a user interface 110. The user interface 110 may be any user interface 110 that is displayed on an output device 106 such as a display device for a given computing device. In some embodiments, the user interface 110 may be included in an operating system. The user interface 110 allows a user to interact with the computing device, including programs, files and other data. In one embodiment, the user interface 110 includes one or more UI controls 114. The UI control 114 may include any type of control that allows the user to interact with any part of the user interface 110. Some embodiments of UI controls 114 may include separator widgets—such as sashes or column separators—hyperlinks, buttons, or other interactive controls. These UI controls 114 may control size or space allocations of areas within the user interface 110, such as panes, column widths, and row widths. In some embodiments, the UI control 114 may perform additional or other operations within the operating system.

In one embodiment, the enhanced cursor system 100 includes a driver 112 associated with a cursor 116 that allows the user to interact with the user interface 110 using a mouse, trackpad, touch screen, or other input device for operating a cursor 116. The driver 112 may determine how the cursor 116 interacts within the user interface 110. In some embodiments, some or all of the operations described herein are implemented at the driver 112. The driver 112 may be associated with the operating system.

In one embodiment, the UI control 114 includes a hot spot region 124 that determines a specific area within the user interface 110 in which the user may activate the UI control 114. The hot spot region 124 may be defined by a location of the UI control 114 in the user interface 110. The UI control 114 may include a visual representation (such as a column separator bar) within the user interface 110 to allow the user to more easily activate the UI control 114. The hot spot region 124 may include some or all of the visual representation of the UI control 114. In some embodiments, the hot spot region 124 extends beyond the visual representation of the UI control 114, such that the user may activate the UI control 114 outside the visual representation.

In one embodiment, the enhanced cursor system 100 is configured to detect hover events 118 by the cursor 116 in which the cursor 116 hovers over the hot spot region 124 for the UI control 114. The enhanced cursor system 100 enables a handle mode 120 in response to detecting the hover event 118. In some embodiments, the enhanced cursor system 100 initiates the handle mode 120 immediately in response to detecting the hover event 118. In other embodiments, the enhanced cursor system 100 only initiates the handle mode 120 if the hover event 118 exceeds a predetermined time threshold 122.

When the cursor 116 enters the handle mode 120, the size of the hot spot region 124 may be extended to make it easier for the user to locate and activate the UI control 114. The hot spot region 124 is extended as long as the cursor 116 is in handle mode 120. In one embodiment, the cursor 116 exits handle mode 120 when the cursor 116 exits the extended hot spot region 124. When the cursor 116 exits handle mode 120, the hot spot region 124 is restored to its original size. If a visual depiction of the cursor 116 is altered upon entering handle mode 120, the visual depiction is also restored in response to the cursor 116 exiting handle mode 120.

In some embodiments, the user may be able to customize functionalities of the handle mode 120, including the size of the extended hot spot region 124, the visible depiction of the cursor 116 while in handle mode 120 or other functionalities.

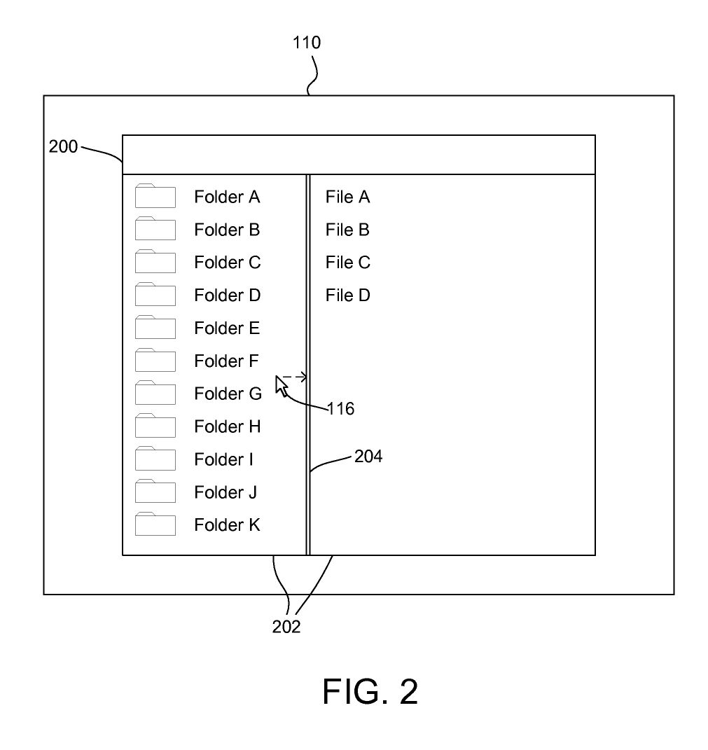

FIGS. 2-4 depict schematic diagrams of various embodiments of a user interface 110. While the enhanced cursor system 100 is described herein in conjunction with the user interface 110 of FIG. 2, the enhanced cursor system 100 may be used in conjunction with any user interface 110.

The user interface 110 may include applications with which the user may interact. In some embodiments, an application is displayed in one or more windows 200 on the display device. The window 200 may include several elements that are displayed in multiple panes 202, and the division between the panes 202 may be displayed using a UI control 114 such as a pane or column separator 204. In some embodiments, the position of the separator 204 may be altered by selecting the separator 204 with the cursor 116 and dragging the separator 204 to a desired new location. This may result in expanding one or more panes 202 and contracting or shrinking one or more panes 202 within the window 200, and may alter the amount or size of content displayed within each pane 202. In other embodiments, the UI control 114 may be a window edge that may be dragged to alter the size or position of the window 200 within the user interface 110.

In one embodiment, the pane separator 204 divides a first column of folders and/or files from a second column of folders and/or files nested within one of the folders from the first column. As shown in FIG. 2, as the mouse approaches the UI control 114 (the pane separator 204, in this embodiment), the cursor 116 may stay outside of the hot spot region 124 of the UI control 114 until the cursor 116 hovers over the UI control 114. Consequently, in the present embodiment, until the cursor 116 moves within the hot spot region 124, the cursor 116 does not enter handle mode 120 and the visual depiction of the cursor 116 does not change.

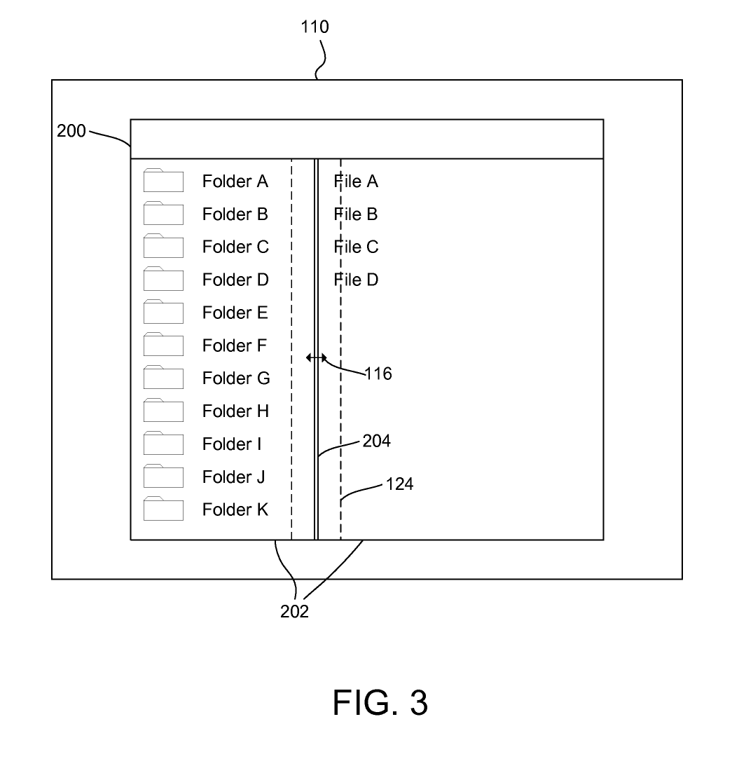

When the cursor 116 enters the hot spot region 124 for the UI control 114, the enhanced cursor system 100 initiates handle mode 120 for the cursor 116. As shown in FIG. 3, when the cursor 116 enters handle mode 120, the enhanced cursor system 100 extends the boundary of the hot spot region 124. In one embodiment, the hot spot region 124 is extended by a predetermined amount or to a predetermined size.

In some embodiments, the UI control 114 is a bar that extends from a bottom to a top of a window 200 or screen. In such embodiments, the hot spot region 124 may be extended along a horizontal direction along the length of the bar. For example, in the embodiment of FIG. 3, the hot spot region 124 for the pane separator 204 is extended in each horizontal direction along the length of the pane separator 204. In some embodiments, the hot spot region 124 may be extended the same amount in each direction from the UI control 114 when the cursor 116 enters handle mode 120.

In another embodiment, the hot spot region 124 is extended in only one direction, based on the motion of the cursor 116. For example, the enhanced cursor system 100 may track the cursor 116 movement and extend the hot spot region 124 only in the direction that the cursor 116 is detected to be moving at the time handle mode 120 is initiated for the cursor 116. If the cursor 116 is moving to the right when the cursor 116 enters handle mode 120, the hot spot region 124 may be extended only to the right. If the cursor 116 is moving to the left when the cursor 116 enters handle mode 120, the hot spot region 124 may be extended only to the left.

In one embodiment, a visual depiction for the cursor 116 is modified when the cursor 116 enters handle mode 120. For example, if the UI control 114 is for a separator control, such as the pane separator 204 displayed in FIG. 3, the cursor 116 changes to a double-ended arrow when the cursor 116 hovers over the hot spot region 124 and enters handle mode 120. In some embodiments, the cursor 116 may change to another visual depiction. In other embodiments, the visual depiction of the cursor 116 does not change when the cursor 116 enters handle mode 120. In some embodiments, a visual depiction of the UI control 114 is altered when the cursor 116 enters the hot spot region 124. For example, when the cursor 116 hovers over the hot spot region 124 and enters handle mode 120, the enhanced cursor system 100 may detect the hover event 118 and highlight the UI control 114.

In one embodiment, the cursor 116 is displayed using a hand with a finger pointing to the current position of the cursor 116. When the cursor 116 enters handle mode 120 and the cursor 116 is moved to a position outside the original boundary of the hot spot region 124, the finger is stretched between the starting position and the current position of the cursor 116. Other embodiments of cursors 116 and UI controls 114 may be used according to the system and method described herein.

The extended hot spot region 124 may be maintained while the cursor 116 remains in handle mode 120. In one embodiment, the cursor 116 exits handle mode 120 if the cursor 116 exits the extended hot spot region 124. In another embodiment, the cursor 116 exits handle mode 120 after the user activates the UI control 114 and performs an operation even if the cursor 116 is still in the extended hot spot region 124, but outside of the original hot spot region 124.

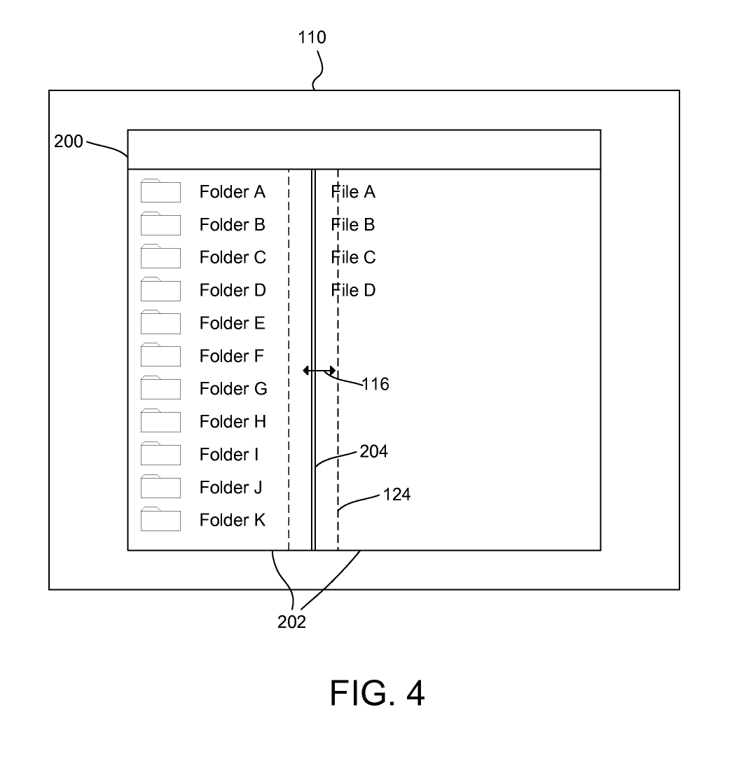

The enhanced cursor system 100 may track movement of the cursor 116 within the user interface 110. When the cursor 116 enters handle mode 120 by hovering over the hot spot region 124, the enhanced cursor system 100 tracks the cursor 116 to determine whether the cursor 116 leaves the extended hot spot region 124. While the cursor 116 remains within the boundaries of the extended hot spot region 124, the enhanced cursor system 100 may stretch the cursor 116 between a starting position of the cursor 116 and a current position of the cursor 116, as shown in FIG. 4.

In one embodiment, the starting position of the cursor 116 corresponds to a horizontal and/or vertical position of the location within the original boundary of the hot spot region 124. The location within the original boundary may be located in any part of the original boundary of the hot spot region 124. For example, in an embodiment in which the UI control 114 is a pane separator 204, the enhanced cursor system 100 may determine a current position of the cursor 116 within the hot spot region 124 and determine a starting position located on the opposite side of the pane separator 204 relative to the current position. Thus, the starting position may be dependent on the current position of the cursor 116, such that the cursor 116 may be stretched across the UI control 114 regardless of where the cursor 116 is located within the hot spot region 124.

In another embodiment, the starting position of the cursor 116 corresponds to a horizontal and/or vertical position of the cursor 116 when the cursor 116 first entered handle mode 120. As the cursor 116 moves within the extended hot spot region 124, the enhanced cursor system 100 tracks the current position of the cursor 116. The cursor 116 may then be stretched between the starting position corresponding to the location where the cursor 116 first entered handle mode 120 and the current position of the cursor 116.

In one embodiment, the starting position of the cursor 116 corresponds to only one of the horizontal and vertical position (or axis) of the cursor 116 when the cursor 116 first entered handle mode 120, such that the starting position may slide along the corresponding axis as the current position moves along that same axis. In another embodiment, the starting position corresponds to the vertical and horizontal position of the cursor 116 when the cursor 116 first entered handle mode 120, such that the starting position of the cursor 116 is static and the cursor 116 is stretched between the static starting position and the current position of the cursor 116.

In one embodiment, when the user activates the UI control 114 while the cursor 116 is in handle mode 120, either by a mouse-down event or another user action, the enhanced cursor system 100 snaps the cursor 116 to the starting position, such that the cursor 116 is displayed within the original boundary of the hot spot region 124. This may provide visual feedback to the user that the user has activated or has begun activating the UI control 114. For example, if the UI control 114 is a pane separator 204, when the user activates the pane separator 204 while the cursor 116 is in handle mode 120 and anywhere within the extended boundary of the hot spot region 124, the enhanced cursor system 100 may return the current position of the cursor 116 to the starting position and allow the user to move the pane separator 204 by dragging the cursor 116. As long as the user maintains the user action, the enhanced cursor system 100 will allow the pane separator 204 to be dragged using the cursor 116. In another embodiment corresponding to a UI control 114 such as a button or hyperlink, performing the user action to activate the UI control 114 while the cursor 116 is in handle mode 120 will restore the cursor 116 to the starting position, which corresponds to any position within the original boundary of the hot spot region 124, such as the nearest visible position on the button or hyperlink to the current position of the cursor 116.

FIG. 5 depicts a flow chart diagram of one embodiment of a method 500 for enhanced cursor interaction with a user interface control 114. Although the method 500 is described in conjunction with the enhanced cursor system 100 of FIG. 1, embodiments of the method 500 may be implemented with other types of enhanced cursor systems 100.

In one embodiment, the enhanced cursor system 100 detects 505 a hover event 118 by a cursor 116 within a hot spot region 124 of the UI control 114 within a user interface 110 and displayed on a display device. The user interface 110 may be displayed on any type of display device. The enhanced cursor system 100 initiates 510 a handle mode 120 for the cursor 116 in response to detecting the hover event 118. When the cursor 116 enters handle mode 120, the enhanced cursor system 100 extends 515 the hot spot region 124 beyond an original boundary. The original boundary of the hot spot region 124 may be limited by a visual depiction of the UI control 114 on the user interface 110, in some embodiments. In other embodiments, the original boundary of the hot spot region 124 may be determined or defined by some other method. In one embodiment, the enhanced cursor system 100 initiates the handle mode 120 and extends the hot spot region 124 beyond the original boundary if the hover event 118 exceeds a predetermined time threshold 122.

In one embodiment, the enhanced cursor system 100 is configured to change a visual depiction of the cursor 116 to a handle mode specific cursor. The visual depiction of the cursor 116 in handle mode 120 may be a predefined cursor icon corresponding to the UI control 114. For example, the cursor 116 may change from a default arrow pointer to a double-ended arrow when the cursor 116 enters the hot spot region 124 for a pane separator 204, to a hand pointer when the cursor 116 enters the hot spot region 124 for a button, or another visual depiction.

In one embodiment, the enhanced cursor system 100 is configured to visually stretch 520 the cursor 116 to extend from a starting position of the cursor 116 to a current position of the cursor 116 while the cursor 116 is in handle mode 120.

For example, if the cursor 116 is depicted as a double-ended arrow while in handle mode 120, the double-ended arrow may be stretched from the starting position to the current position, such that a first end of the arrow is positioned at the starting position and a second end of the arrow is positioned at the current position. In one embodiment, the cursor 116 is stretched only if the current position of the cursor 116 is located outside of the original boundary of the hot spot region 124 and within the extended boundary.

The starting position may include any location corresponding to at least one of a horizontal and vertical position within the original boundary of the hot spot region 124. As described herein, the starting position may be determined by an initial vertical and/or horizontal position of the cursor 116 when the cursor 116 first enters handle mode 120. The starting position may additionally or alternatively be determined based on the current position of the cursor 116 within the extended hot spot region 124.

In one embodiment, the enhanced cursor system 100 detects a user action to activate the UI control 114 while the cursor 116 is in handle mode 120, positions the cursor 116 at the starting position, and activates the UI control 114 corresponding to the user action. Consequently, as long as the current position of the cursor 116 is within the extended boundary of the hot spot region 124, the enhanced cursor system 100 may move the cursor's current position to the starting position in response to a user action to activate the UI control 114.

In one embodiment, the enhanced cursor system 100 may continuously track the position of the cursor 116 to check 525 if the cursor 116 is still within the extended hot spot region 124. While the cursor 116 stays within the extended hot spot region 124, the cursor 116 remains 530 in handle mode 120. If the cursor 116 exits the extended hot spot region 124, the cursor 116 exits 535 handle mode 120 and the enhanced cursor system 100 restores 540 the hot spot region 124 to the original boundary. When the cursor 116 exits handle mode 120, the visual depiction of the cursor 116 may be restored to a default visual depiction or to another visual depiction of a cursor 116 corresponding to the hot spot region 124 of another element within the user interface 110.

An embodiment of an enhanced cursor system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a non-transitory computer usable storage medium for execution by a computer. As an example, an embodiment of a computer program product includes a computer usable storage medium to store a computer readable program that, when executed on a computer, causes the computer to perform operations, including an operation for enhanced cursor interaction with a UI control 114.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-usable or computer-readable medium can be an electronic, magnetic, optical, electromagnetic, infrared, or semiconductor system (or apparatus or device), or a propagation medium. A computer readable storage medium or device is a specific type of computer-readable or -usable medium. Examples of a computer-readable storage medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for enhanced cursor interaction with a user interface (UI) control, the operations comprising:
detecting a hover event by a cursor within a hot spot region of the UI control within a user interface, wherein the user interface is displayed on a display device;
initiating a handle mode for the cursor in response to detecting the hover event and
extending the hot spot region beyond an original boundary in response to initiating handle mode.

2. The computer program product of claim 1, wherein the computer readable program, when executed on the computer, causes the computer to perform additional operations, comprising:
exiting the handle mode in response to the cursor leaving the hot spot region extended by the handle mode; and
restoring the hot spot region to the original boundary.

3. The computer program product of claim 2, wherein the computer readable program, when executed on the computer, causes the computer to perform additional operations, comprising:
changing a visual depiction of the cursor to an elastic handle mode specific cursor;
restoring the cursor to a default visual depiction in response to the cursor exiting the handle mode.

4. The computer program product of claim 1, wherein the computer readable program, when executed on the computer, causes the computer to perform additional operations, comprising:
tracking a current position of the cursor in relation to a starting position of the cursor, wherein the starting position corresponds to at least one of a horizontal position and a vertical position within the original boundary of the hot spot region; and
visually stretching the cursor to extend from the starting position to the current position.

5. The computer program product of claim 4, wherein the computer readable program, when executed on the computer, causes the computer to perform additional operations, comprising:
detecting a user action to activate the UI control while the cursor is in the handle mode;
positioning the cursor at the starting position; and
activating the UI control corresponding to the user action.

6. The computer program product of claim 4, wherein the UI control is a separator control, wherein the computer readable program, when executed on the computer, causes the computer to perform additional operations, comprising:
displaying the cursor as a double-ended arrow; and
stretching the arrow from the starting position to the current position, wherein a first end of the arrow is positioned at the starting position and a second end of the arrow is positioned at the current position.

7. The computer program product of claim 1, wherein initiating the handle mode further comprises determining that the hover event exceeds a predetermined time threshold before extending the hot spot region beyond the original boundary.

8. A method for enhanced cursor interaction with a user interface (UI) control, comprising:
detecting a hover event by a cursor within a hot spot region of the UI control within a user interface, wherein the user interface is displayed on a display device;
initiating a handle mode for the cursor in response to detecting the hover event; and
extending the hot spot region beyond an initial boundary in response to initiating the handle mode.

9. The method of claim 8, further comprising:
exiting the handle mode in response to the cursor leaving the hot spot region extended by the handle mode; and
restoring the hot spot region to the original boundary.

10. The method of claim 9, further comprising:
changing a visual depiction of the cursor to an elastic handle mode specific cursor;
restoring the cursor to a default visual depiction in response to the cursor exiting the handle mode.

11. The method of claim 8, further comprising:
tracking a current position of the cursor in relation to a starting position of the cursor, wherein the starting position corresponds to at least one of a horizontal position and a vertical position within the original boundary of the hot spot region; and
visually stretching the cursor to extend from the starting position to the current position.

12. The method of claim 11, further comprising:
detecting a user action to activate the UI control while the cursor is in the handle mode;
positioning the cursor at the starting position; and
activating the UI control corresponding to the user action.

13. The method of claim 11, further comprising:
displaying the cursor as a double-ended arrow; and
stretching the arrow from the starting position to the current position, wherein a first end of the arrow is positioned at the starting position and a second end of the arrow is positioned at the current position.

14. The method of claim 8, wherein initiating the handle mode further comprises determining that the hover event exceeds a predetermined time threshold before extending the hot spot region beyond the original boundary.

15. A system for enhanced cursor interaction with a user interface (UI) control, comprising:
a driver configured to:
detect a hover event by a cursor within a hot spot region of the UI control within a user interface, wherein the user interface is displayed on a display device;
initiate a handle mode for the cursor in response to detecting the hover event; and
extend the hot spot region beyond an initial boundary in response to initiating the handle mode.

16. The system of claim 15, wherein the driver is further configured to:
exit the handle mode in response to the cursor leaving the hot spot region extended by the handle mode; and
restore the hot spot region to the original boundary.

17. The system of claim 15, wherein the driver is further configured to:
track a current position of the cursor in relation to a starting position of the cursor, wherein the starting position corresponds to at least one of a horizontal position and a vertical position within the original boundary of the hot spot region; and
visually stretch the cursor to extend from the starting position to the current position.

18. The system of claim 17, wherein the driver is further configured to:
detect a user action to activate the UI control while the cursor is in the handle mode;
position the cursor at the starting position; and
activating the UI control corresponding to the user action.

19. The system of claim 17, wherein the driver is further configured to:
display the cursor as a double-ended arrow; and
stretch the arrow from the starting position to the current position, wherein a first end of the arrow is positioned at the starting position and a second end of the arrow is positioned at the current position.

20. The system of claim 15, wherein initiating the handle mode further comprises determining that the hover event exceeds a predetermined time threshold before extending the hot spot region beyond the original boundary.
